(19) United States
(12) Patent Application Publication
(10) Pub. No.: US 2008/0041994 A1
(43) Pub. Date: Feb. 21, 2008

(54) A Replaceable Wear Liner with Super Hard Composite Inserts

(76) Inventors: David R. Hall, Provo, UT (US); Joe Fox, Spanish Fork, UT (US); Tyson J. Wilde, Spanish Fork, UT (US)

Correspondence Address: TYSON J. WILDE;NOVATEK INTERNATIONAL, INC., 2185 SOUTH LARSEN PARKWAY, PROVO, UT, 84606, US

(21) Appl. No.: 11/426,202

(22) Filed: Jun. 23, 2006

(51) Int. Cl. B02C 15/10

(52) U.S. Cl. 241/207

(57) ABSTRACT

In one aspect of the invention, a rock crusher has a crushing chamber disposed between two opposing walls and at least one of the walls comprising a replaceable wear liner. The replaceable wear liner has a plurality of super hard composite inserts disposed within a plurality of cavities formed in a crushing surface of the replaceable wear liner. The super hard composite inserts have a layer of diamond or cubic boron nitride.

### BACKGROUND OF THE INVENTION

Replaceable wear liners are often incorporated into cone crushers to form the crushing surfaces used to crush various materials. Cone crushers typically comprise of an eccentric assembly that rotates about a stationary shaft resulting in a gyratory motion which is harnessed to crush material as it traverses between crushing surfaces in the crushing chamber where the replaceable wear liners are located. Material to be crushed is effectively reduced into smaller dimensions as a result of being subjected to compression between the tapered crushing surfaces of the crushing chamber. The reduced material then exits from a gap between the crushing surfaces sometimes called the “closed side setting” where the minimum width of the reduced material is predetermined by manipulating the closed side setting in accordance with the desired geometry of the reduced material. The final product consists of material that possesses the desired geometry or ratio of length to width to thickness for various applications such as road surfacing, paving, landscaping and so forth.

Over time the replaceable wear liner may begin to deteriorate such that the space between the crushing surfaces become distorted which consequently reduces the crushers ability to produce the desired geometry resulting in irregular or substandard final product material. Substandard product may require that the replaceable wear liner be serviced or replaced. Consequently, the time required to properly address wear issues equates to significant economic loss both in terms of maintenance and production loss.

In the prior art, U.S. Pat. Nos. 5,967,431 and 6,123,279 as well as U.S Patent Publication No. 2003/0136865 of which are herein incorporated by reference for all that they contain, disclose cone crushers which may be compatible with the present invention.

### BRIEF SUMMARY OF THE INVENTION

One aspect of the present invention is to provide a replaceable wear liner with super hard composite inserts in a crusher, the replaceable wear liner forming a crushing surface and protecting at least one wall of a crushing chamber in the crusher. The super hard composite inserts serve to enhance the disintegration of various materials, such as rock or used asphalt, and/or to improve the geometry of the crushed material while also prolonging the life of the replaceable wear liner.

In one embodiment the replaceable wear liner may comprise of a base segment of manganese, steel, stainless steel, or combinations thereof. In another embodiment the replaceable wear liner may further comprise a layer of cemented metal carbide selected from the group consisting of tungsten carbide, niobium carbide, and manganese carbide which may assist to extend the wear resistance of the replaceable wear liner. Preferably the replaceable wear liner is configured for either a conical head or concave bowl of a cone crusher for integration and may further comprise of a plurality of cavities to house super hard composite inserts. In other embodiments, the replaceable wear liner is adapted to protect the walls of the crushing chamber in jaw crushers.

Another embodiment of the present invention comprises the super hard composite inserts which may comprise a substrate that forms a base segment that may feature a tapered or flange end for reception into a corresponding cavity of the replaceable wear liner. The tip of the insert is coated with a superhard material selected from diamond, natural diamond, vapor deposited diamond, polycrystalline diamond, cubic boron nitride or other super hard composite materials which tend to exhibit low thermal expansion rates and are generally chemically inert. The tip may further comprise of a shape selected from a generally elliptic paraboloid shape, a generally rounded shape, a generally conical shape, a generally pyramidal shape, a generally triangular shape, a generally frustoconical shape, a generally flat shape, a generally asymmetric shape, a generally domed shape, a generally wedge shape, a generally scoop shape, a general polygonal shape, a chamfer, a conic section, or combinations thereof that would assist to reduce the deterioration of the insert and improve the ability to crush material. The inserts may be deposed around the circumference of the crushing surface of the replaceable wear liner to protrude towards an opposing crushing surface of either a conical head or concave bowl of the crushing chamber. The inserts act to shatter materials that traverse between the two surfaces and assist to enhance performance and durability of the replaceable wear liners. Some unique characteristics of the super hard composite inserts may be attributed to their high thermal stability and wear resistant properties.

Another aspect of the invention is to provide wireless transceivers coupled with corresponding sensors selected from the group consisting of an acoustic transducer, a nuclear transducer, an optical transducer, a capacitor, piezoelectric material, a magnetostrictive material, a solenoid, hydraulics, an actuator, or combinations thereof, and integrated within a portion of the replaceable wear liner to monitor vibration, orientation, temperature, pressure, strain, stress, rotational speed, electric potential, position, corrosion, pH, particle density, particle size, wear, distance, displacement, flow rate, magnetism, or combinations thereof. The wireless transceivers and corresponding sensors may serve to enhance preventive maintenance capabilities by allowing the operator to detect variances in the replaceable wear liner which could be attributed to wear and also the allowing the operator to monitor the consistency of geometry of final product material.

### BRIEF DESCRIPTION OF THE DRAWINGS

FIG. 1 is a perspective cross-sectional diagram of an embodiment of a cone crusher with a replaceable wear liner.

FIG. 2 is a perspective cross-sectional diagram of another embodiment of a cone crusher with a replaceable wear liner.

FIG. 3 is a perspective cross-sectional diagram of another embodiment of a cone crusher with a replaceable wear liner.

FIG. 4 is top perspective diagram of an embodiment of a conical head replaceable wear liner.

FIG. 5 is top perspective diagram of another embodiment of a concave bowl replaceable wear liner.

FIG. 6 is a cross-sectional diagram of an embodiment of a super hard composite insert with a base segment and a first and second layer of super hard material.

FIG. 7 is a perspective cross-sectional diagram of another embodiment of a layer of cemented metal carbide with super hard composite inserts having tapered ends.

FIG. 8 is a perspective cross-sectional diagram of another embodiment of a layer of cemented metal carbide with super hard composite inserts having flanged ends.

FIG. 9 is a perspective cross-sectional diagram of another embodiment of a layer of cemented metal carbide with super hard composite inserts brazed into the replaceable wear liner.

FIG. 10 is a perspective cross-sectional diagram of another embodiment of super hard composite inserts being press fit into a replaceable wear liner.

FIG. 11 is a perspective diagram of another embodiment of the placement of super hard composite inserts in the replaceable wear liner.

FIG. 12 is a perspective sectional diagram of another embodiment of a super hard composite insert with a flat head and a non-planar interface.

FIG. 13 is a perspective sectional diagram of another embodiment of a super hard composite insert with a stepped form.

FIG. 14 is a perspective sectional diagram of another embodiment of a super hard composite insert with a generally cylindrical shape and a conical head.

FIG. 15 is a perspective sectional diagram of another embodiment of a super hard composite insert with a stepped form.

FIG. 16 is a perspective sectional diagram of another embodiment of a super hard composite insert with at least one peak and at least one recess.

FIG. 17 is a perspective sectional diagram of another embodiment of a super hard composite insert that is rounded with a spiral groove formed on it.

FIG. 18 is a perspective sectional diagram of another embodiment of a super hard composite insert that is frustoconical with a conic section form on its plateau.

FIG. 19 is a perspective sectional diagram of another embodiment of a super hard composite insert that is rectangular with a concave inwardly sloping top.

FIG. 20 is a perspective sectional diagram of another embodiment of a super hard composite insert that is generally rectangular.

FIG. 21 is a perspective sectional diagram of another embodiment of a super hard composite insert that is frustoconical with a hard layer bonded to a substrate.

FIG. 22 is a perspective sectional diagram of another embodiment of a super hard composite insert that is generally conical with a rounded tip.

FIG. 23 is a perspective sectional diagram of another embodiment of a super hard composite insert that has a slightly convex top surface.

FIG. 24 is a perspective sectional diagram of another embodiment of a super hard composite insert that is generally pyramidal with a generally triangular top.

FIG. 25 is a perspective sectional diagram of another embodiment of a super hard composite insert with an angled face.

FIG. 26 is a perspective sectional diagram of another embodiment of a super hard composite insert with an asymmetric rounded top.

FIG. 27 is a perspective sectional diagram of another embodiment of a super hard composite insert with a scoop.

FIG. 28 is a perspective sectional diagram of another embodiment of a super hard composite insert with an offset protrusion located on a flat face.

FIG. 29 is a perspective sectional diagram of another embodiment of a super hard composite insert that is rounded to the apex with a convex slope.

FIG. 30 is a perspective sectional diagram of another embodiment of a super hard composite insert that is rounded to the apex with a concave slope.

FIG. 31 is a perspective cross-sectional diagram of another embodiment of a sensor coupled with a wireless transceiver within a portion of the conical head replaceable wear liner.

FIG. 32 is a perspective sectional diagram of an embodiment of a jaw crusher in accordance with the present invention.

FIG. 33 is a perspective cross-sectional diagram of an embodiment of a sensor coupled with a wireless transceiver within a portion of the replaceable wear liner of a jaw crusher.

### DETAILED DESCRIPTION OF THE INVENTION AND THE PREFERRED EMBODIMENT

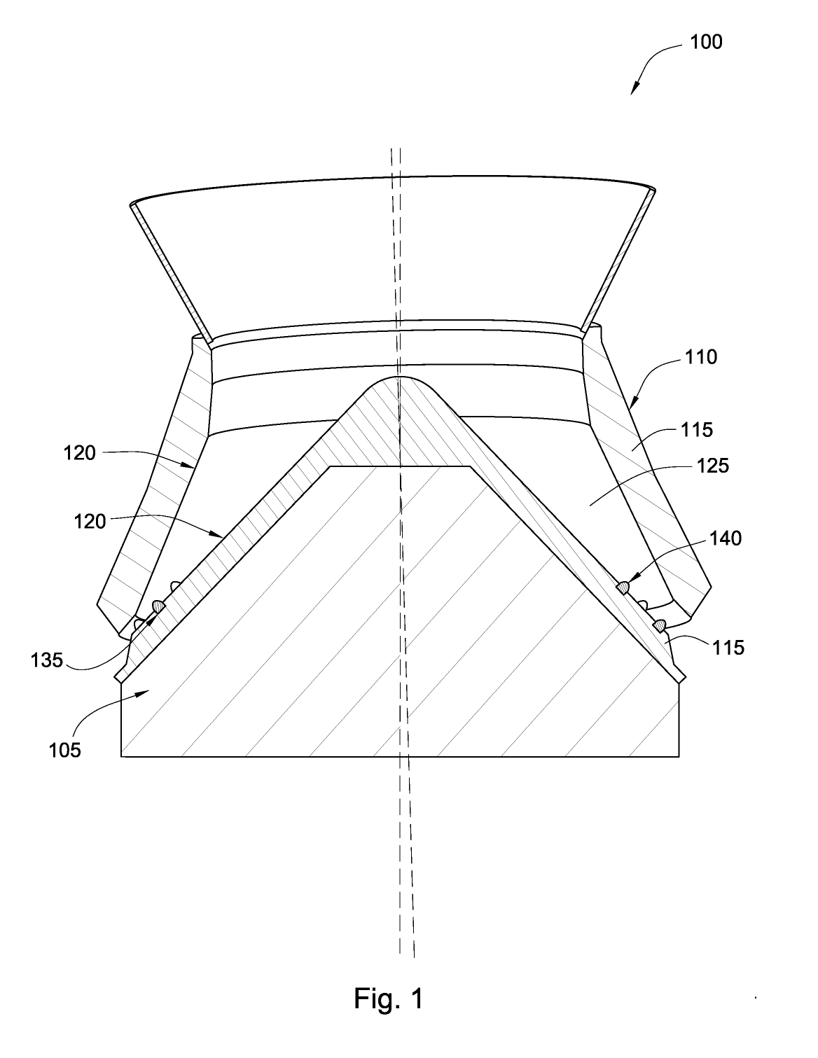

FIG. 1 depicts a cone crusher 100 in accordance with the present invention. The cone crusher 100 may comprise at least one disposable replaceable wear liner 115 configured for either a conical head 105 or a concave bowl 110. The concave bowl 110 is typically connected to a hopper for receiving crushing material such as rock. The conical head 105 and concave bowl 110 may each comprise replaceable wear liners 115 comprised of a material selected from the group consisting of manganese, steel, stainless steel, and combinations thereof, which form the crushing surfaces 120 of the crushing chamber 125. In other embodiments the replaceable wear liner 115 may further comprise a layer of cemented metal carbide 130. The particular type of carbide may be selected from the group consisting of tungsten carbide, niobium carbide, and manganese carbide and the carbide may comprise a thickness ranging from 0.100 to 2.00 inches. The cemented metal carbide may serve to enhance resistance to wear and may assist to prolong the life of the replaceable wear liner 115 in combination with the super hard composite inserts 140. The crushing surface 120 of the replaceable wear liner 115 may also comprise of a plurality of cavities 135 which are formed to accept super hard composite inserts 140. The super hard composite inserts 140 may be incorporated in at least one of the replaceable wear liners 115 extending from one crushing surface 120 towards another opposing crushing surface 120 and may be disposed in such a way to provide optimal disintegration of crushing material while also providing enhanced wear resistance for the replaceable wear liner 115. The super hard composite inserts 140 may be brazed 165 or press fit 170 within the cavities 135. The super hard composite inserts 140 may protrude out of the crushing surface 120 at a range of between 0.100 to 3.00 inches depending on the material to be reduced. In some embodiments the super hard composite inserts 140 do not protrude at all from the crushing surface 120 but are flush or retracted within the cavity 135. In other embodiments the super hard composite inserts 140 are simply bonded to a flat surface of the crushing surface 120. The diameter of the super hard composite inserts 140 may range from 3 mm to 19 mm.

The replaceable wear liner 115 may cover the entire surface area of either the conical head 105 or the concave bowl 110. In some embodiments, only areas susceptible to high wear are lined. A recess may be formed in the surface area of the crushing chamber 125 to accommodate liners that only cover a portion of either the conical head 105 or the concave bowl 110.

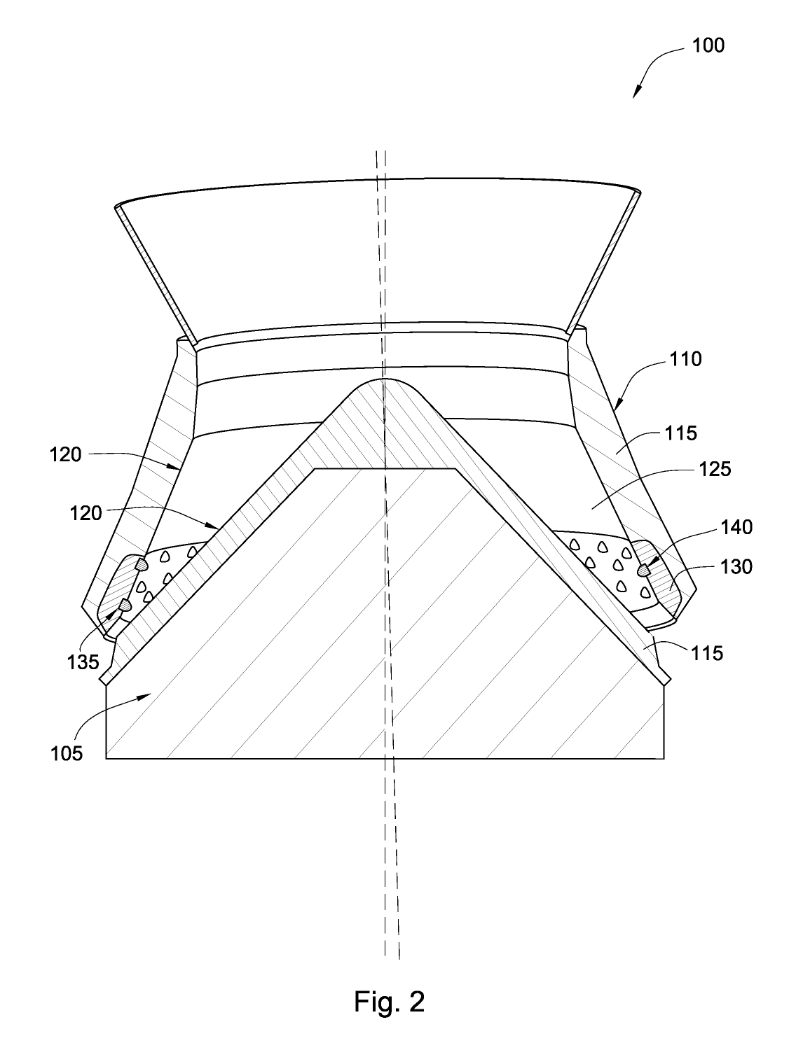

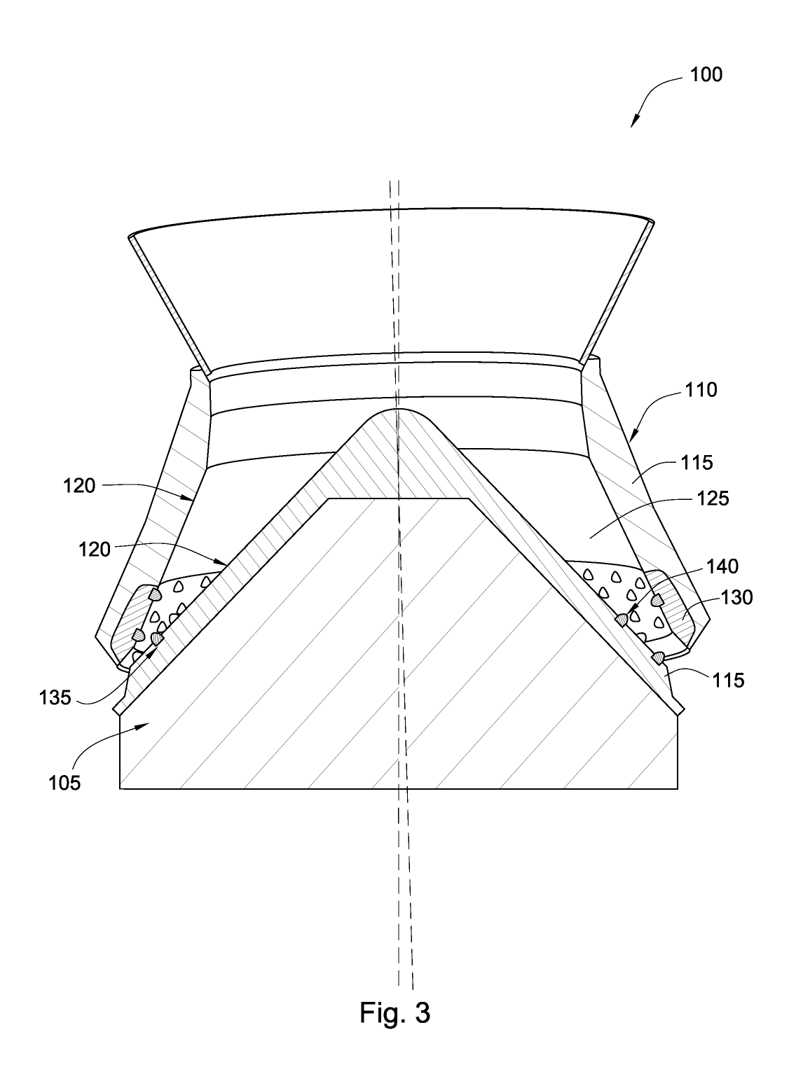

Referring now to FIG. 2, the diagram discloses how the super hard composite inserts 140 may be disposed around a peripheral circumference of the concave bowl 110. FIG. 3 depicts how the super hard composite inserts 140 may also be disposed around a peripheral circumferences of both the conical head 105 and concave bowl 110 forming concentrical circular rows. In other embodiments it may be advantageous to have the super hard composite inserts 140 also disposed in the upper portions of either the conical head 105 or concave bowl 110 in various arrangements or combinations thereof.

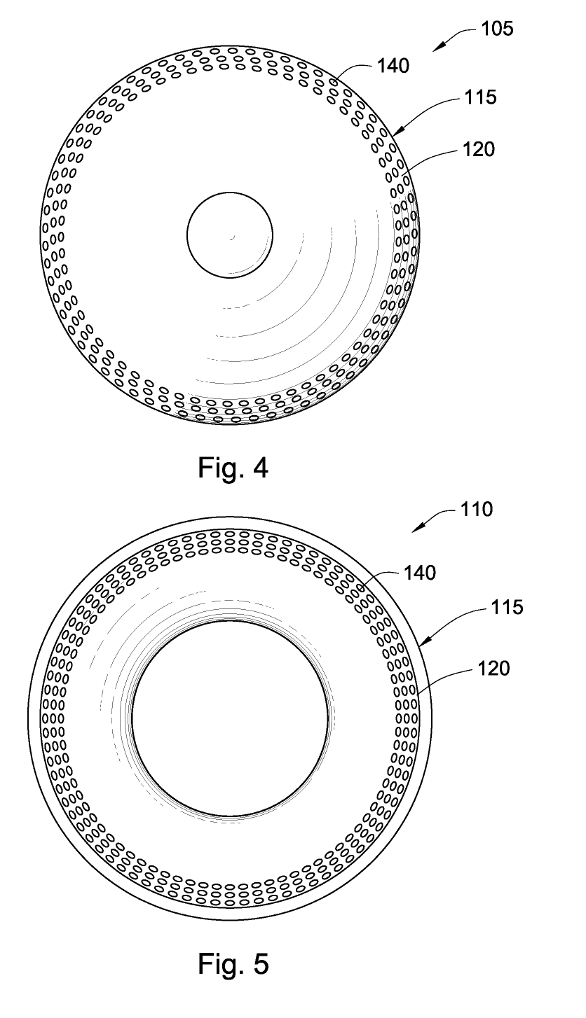

FIG. 4 is a diagram of another embodiment of a cone crusher 100 depicting a replaceable wear liner 115 of a conical head 105 where the arrangement of super hard composite inserts are disposed in circular rows around the lower portion of the replaceable wear liner 115. FIG. 5 is a top perspective diagram of another embodiment of a replaceable wear liner 115 of a concave bowl 105 depicting the arrangement of super hard composite inserts 140 also being disposed in circular rows around the lower portion of the replaceable wear liner 115. The rows may align with each other or the rows may be offset from one another. Preferably, the lower rows comprise more inserts than the upper rows although it is not required. The preferred embodiment is to have the super hard composite inserts 140 disposed within the lower peripheral circumference of the replaceable wear liner 115 of conical head 105 where the liner is most susceptible to wear. This preferred embodiment may assist to counter the erosive deterioration of the replaceable wear liner and improve consistency of the geometry of the size reduced material, preferably the geometry is a generally cubic shape. Yet in other embodiments it may also be advantageous to have the super hard composite inserts 140 disposed within the upper portions of the replaceable wear liner 115 of both the conical head 105 and concave bowl 110 or combinations thereof.

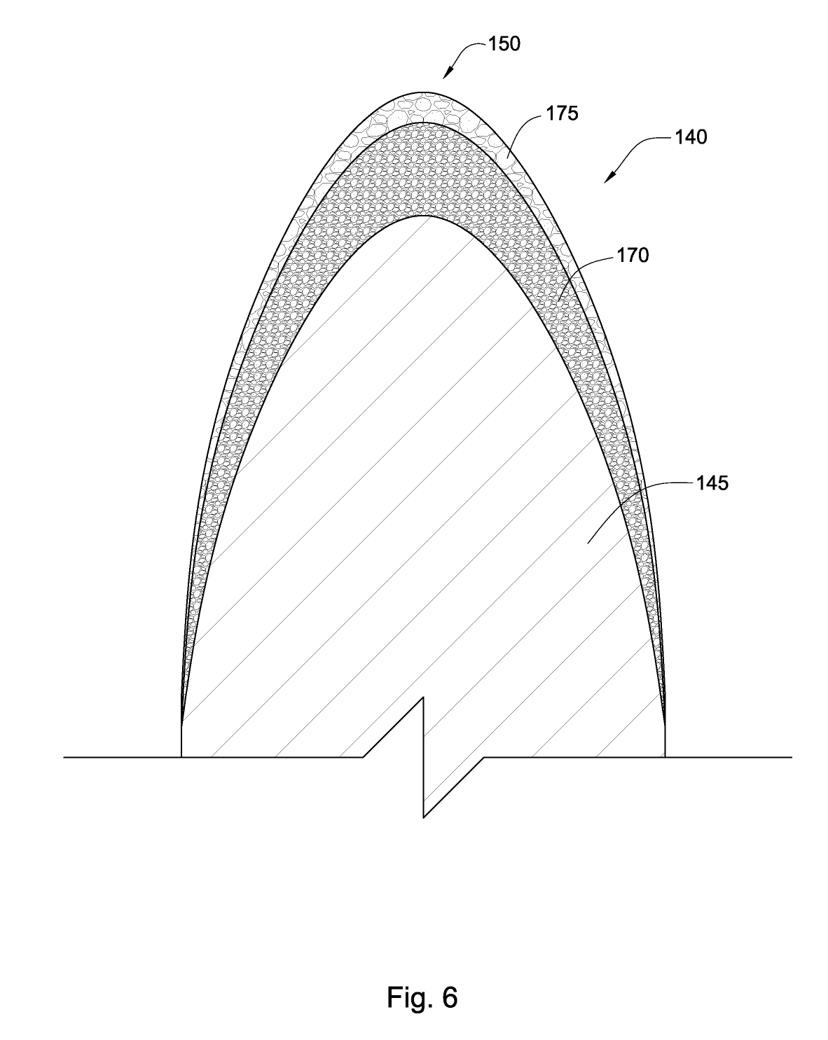

FIG. 6 discloses a composition of the super hard composite inserts 140 which may comprise a solid material or a combination of materials. Preferably the inserts comprise a base segment 145 formed of cemented metal carbide substrate with a super hard material bonded to it forming a tip 150. The tip may comprise polycrystalline diamond. The surfaces of super hard material may comprise of a first layer 175 and second layer 180 selected from the group consisting of natural diamond, synthetic diamond, polycrystalline diamond, single crystalline diamond, cubic boron nitrate, and vapor deposited diamond. The hardness of the surfaces of super hard materials, in some cases, may be adjusted by doping or infiltrating materials with higher or lower concentrations of metals and/or hard materials until a desired hardness is achieved. The hardness of the super hard material may be at least twice as hard as the base of the replaceable wear liner. In other embodiments, the super hard material is at least five times as hard. In the preferred embodiment, a tungsten carbide is used with the preferred insert to form the base segment of the insert. The super hard material may be bonded to the substrate with a non-planar interface to increase the strength of the bond. Also the super hard material may be a sintered body, such as in embodiments where a polycrystalline diamond is used, and may be made thermally stable by removing a thin layer of metal binders (which may have a higher coefficient of thermal expansion than the grains of the super hard material) in the surface by leaching. The super hard material may comprise a metal binder concentration less 40 weight percent. In embodiments, where polycrystalline diamond is used a higher concentration of cobalt typically reduces the brittleness of the polycrystalline diamond but as a tradeoff may increase its susceptibility to wear. In other embodiments the polycrystalline diamond may comprise at least a portion which is produced by high pressure high temperature method without a metal catalyst. Preferably the polycrystalline diamond has a cobalt concentration of 4 to 10 weight percent. Adjusting the metal binder concentration in the cemented metal carbide may also have the same effect. Preferably the carbide is a tungsten carbide comprising a cobalt concentration of 6 to 14 weight percent. Polycrystalline diamond grain size distribution may also play an important role in the strength of the diamond and also in its failure mode. Preferably, the grain sizes in the first layer are within 0.5 to 200 microns while the grain sizes in the second layer are within 0.5 to 300 micron Preferably, the hard surface is also polished to reduce crack initiation points that may be created during manufacturing. Although several preferred characteristics have been identified, any concentrations and characteristics of the superhard material are encompassed within the claims.

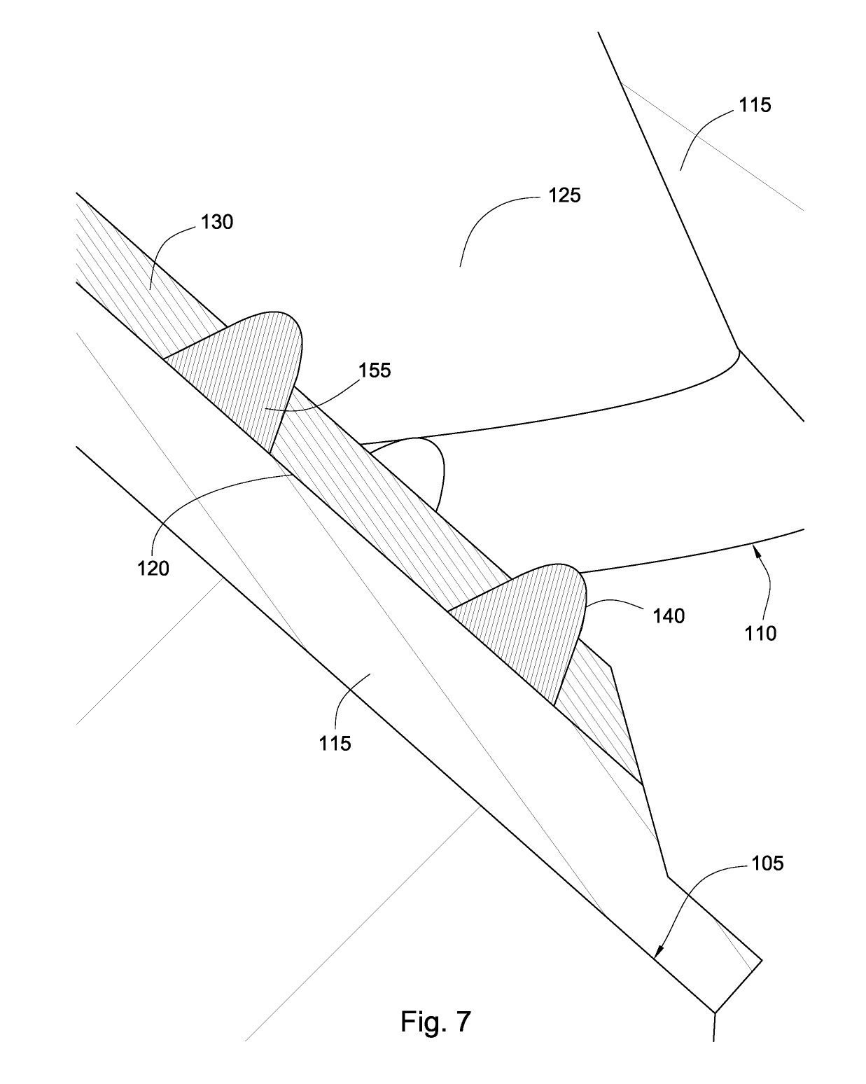

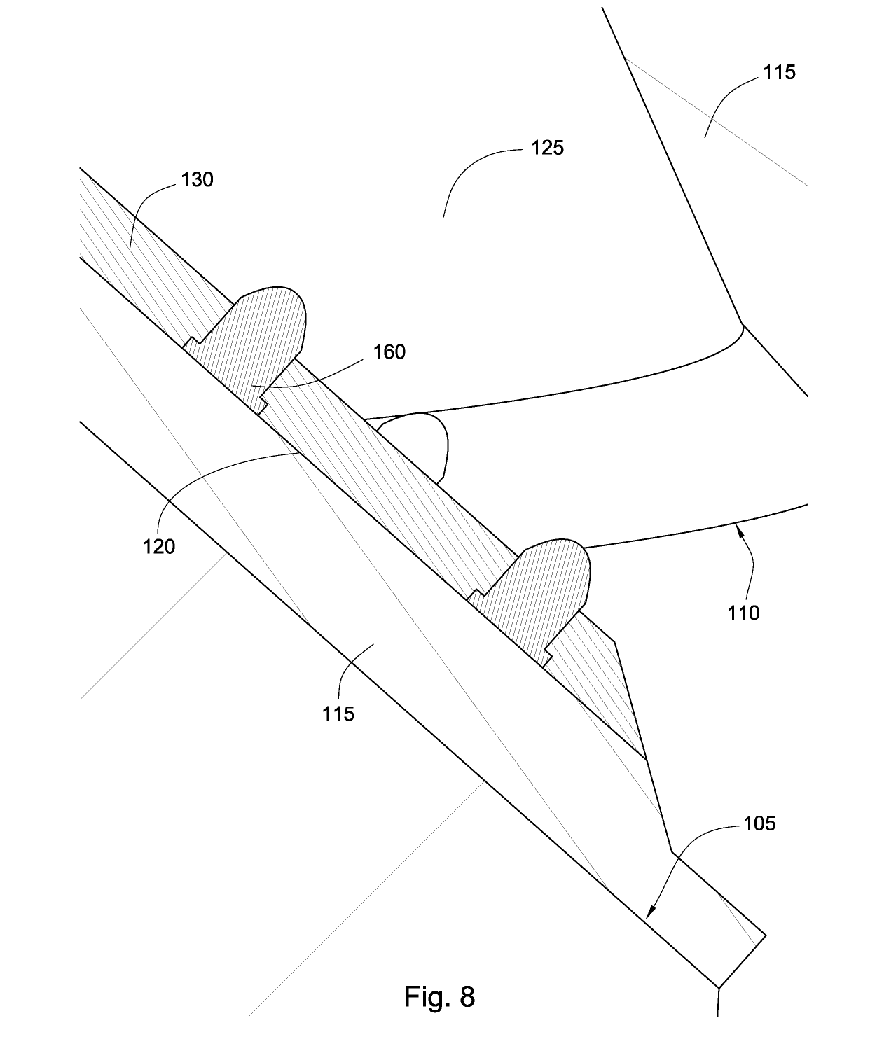

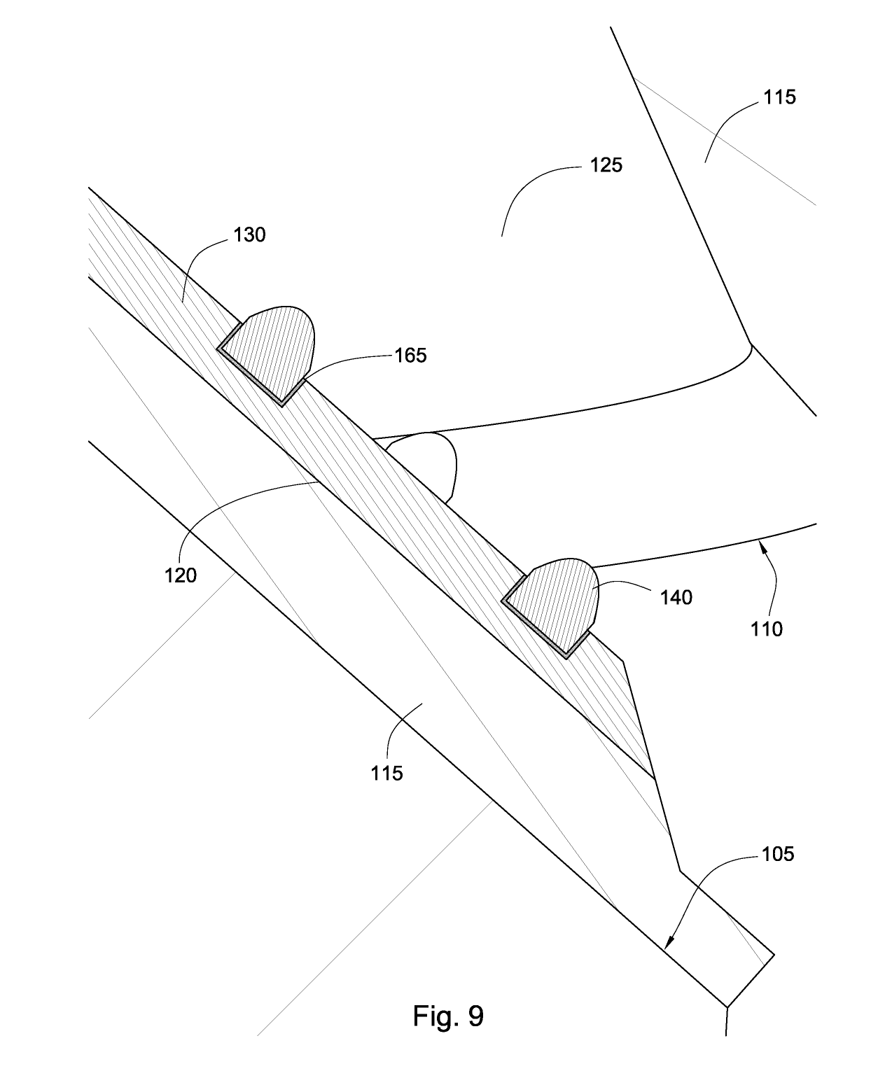

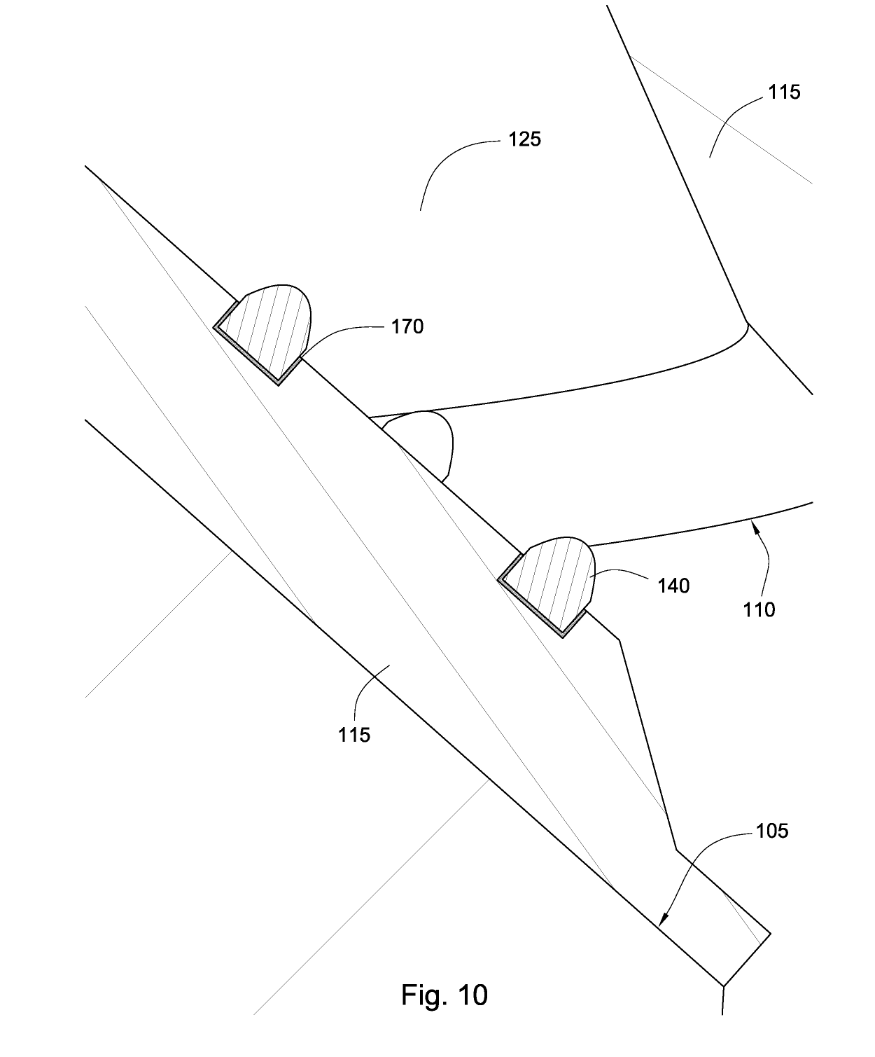

FIGS. 7-10 disclose embodiments depicting various methods of attaching the super hard composite inserts 140 to a replaceable wear liner 115 with a layer of cemented metal carbide 130. In FIG. 7 the base segment 145 of the super hard composite inserts 140 features a tapered end 155 for reception into the cavity 135 of the replaceable wear liner 115 however the substrate may also comprise a flanged end 160 as shown in FIG. 8 or be brazed 165 into the cavity as depicted in FIG. 9. FIG. 10 depicts yet another embodiment of a replaceable wear liner 115 where the super hard composite insert 140 is press fit 170 into the cavity 135 of a replaceable wear liner 115 which is absent the layer of cemented metal carbide 130 of the crushing surface 120. In the embodiments disclosed in FIGS. 7 and 8, the inserts are fitted into the carbide layer before the carbide layer is bonded to the base segment of the replaceable wear liner. In other embodiments, the replaceable wear liner does not have a harder layer such as carbide and the inserts of FIGS. 7 and 8 are installed before liner is attached to a wall of the crushing chamber. In other embodiments, the inserts of FIGS. 7-9 may comprise cavities that extend into both the carbide layer and the base segment of the replaceable wear liner.

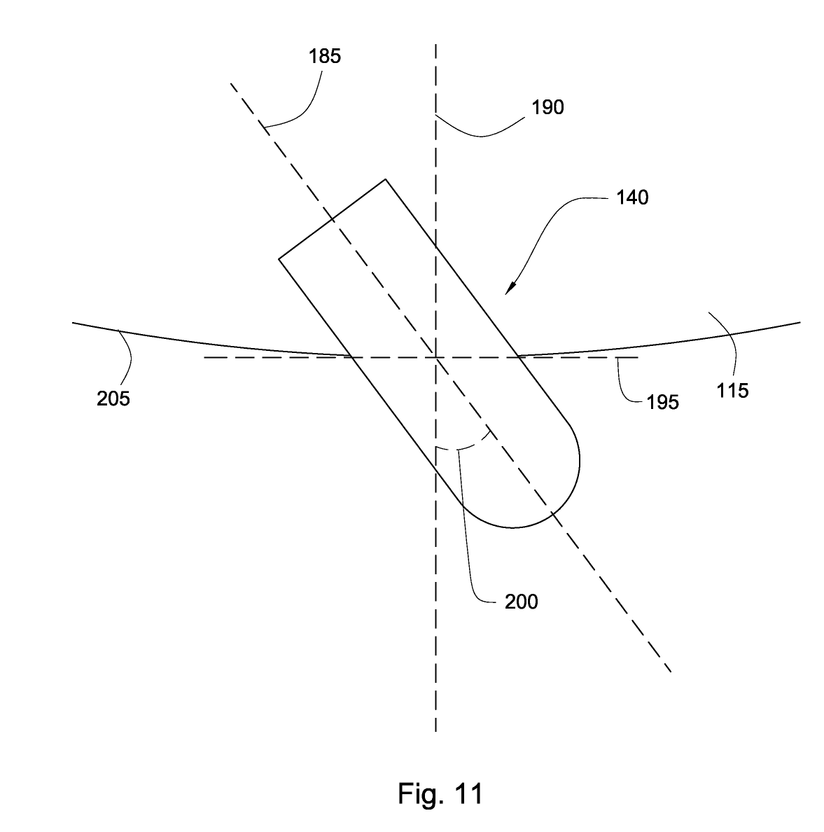

FIG. 11 is a diagram of another embodiment of a replaceable wear liner 115 depicting the axis 185 of a super hard composite insert 140 being positioned at an angle 200 substantially equal or less than 75 degrees with a normal line 190 to the tangent 195 of the replaceable wear liners curvature 205. In some embodiments the angle and direction of rotation at which the super hard composite inserts 140 are set may enhance the reduction of certain types of materials more than other angles as well as improve the replaceable wear liners ability to resist wear.

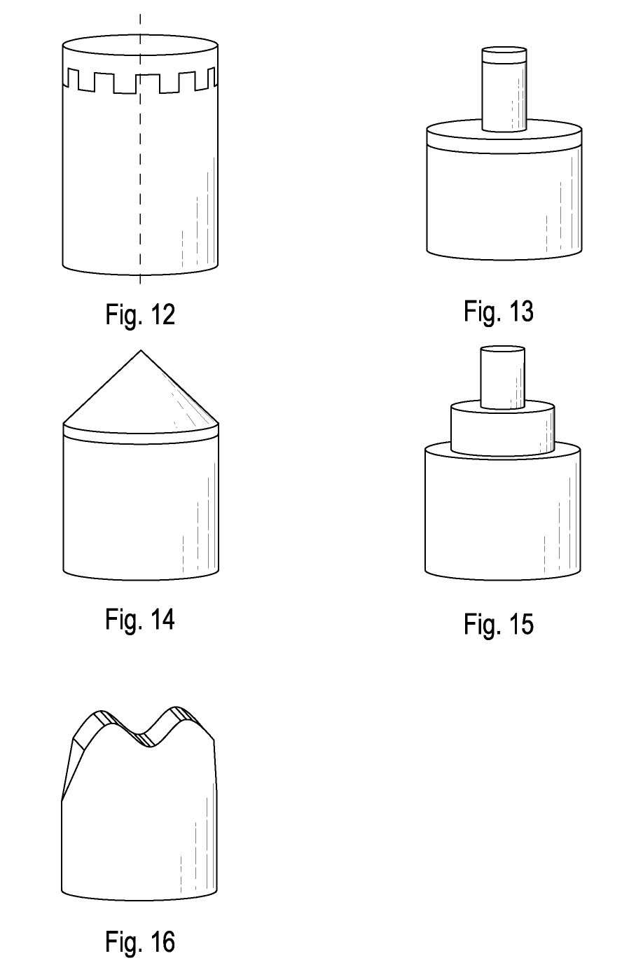

FIGS. 12-30 all disclose various embodiments of geometries of the super hard composite inserts. Each geometry may be advantageous depending on the material and application of the replaceable wear liner. These inserts may be bonded or otherwise attached to any portion of the replaceable wear liner, although they are preferably attached to the lower portion of the replaceable wear liner where it is most prone to wear.

FIG. 12 discloses an insert with a flat head. A non-planar interface between the hard layer and substrate is shown. FIG. 13 discloses a stepped insert. This may be advantageous since the top plateau will contact the material first with a small surface area allowing a greater penetration into the material, thereby weakening the material just before the second plateau contacts the now weakened region of the material allowing the second impact to affect a greater volume of the material. FIG. 14 discloses an insert with a generally cylindrical shape and a conical end. FIG. 15 discloses another embodiment of a stepped insert, but with more plateaus. FIG. 16 discloses an insert with at least one peak and at least one recess.

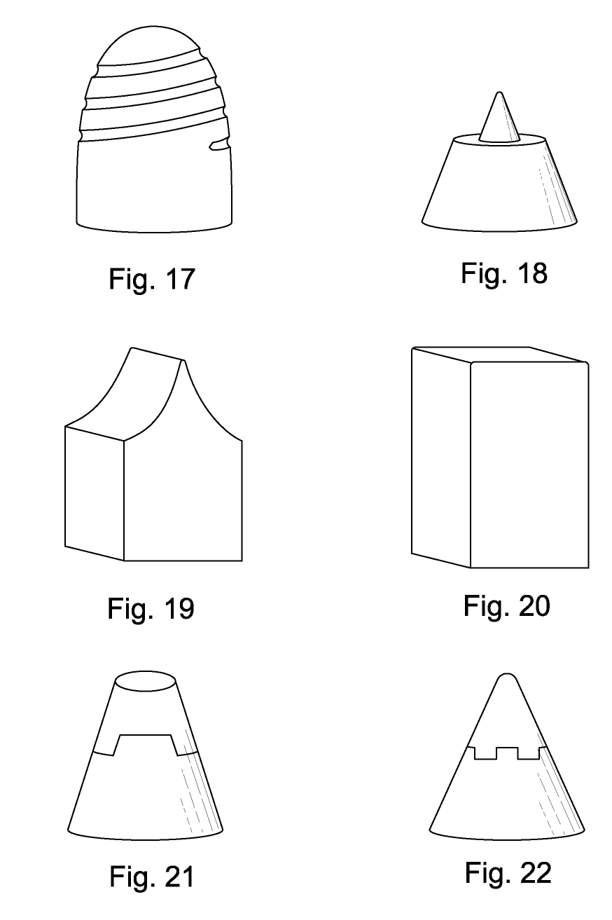

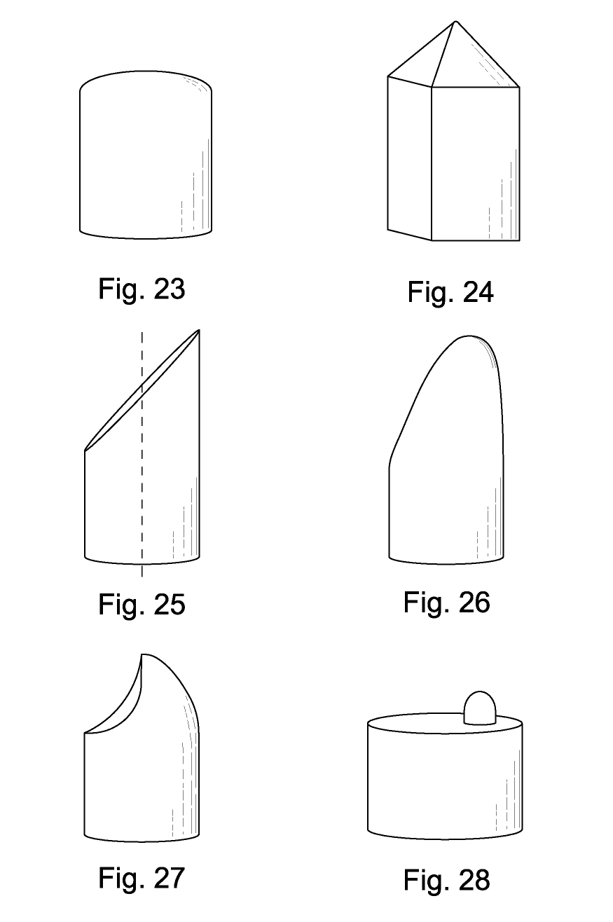

FIG. 17 discloses a rounded insert with a spiral groove formed in it. Any pattern of grooves may be used. Grooves that substantially lie parallel to the axis of the insert may also be beneficial. FIG. 18 discloses a frustoconical insert with a conic section formed on its plateau. FIG. 19 discloses a generally rectangular insert with a concave inwardly sloping top. FIG. 20 discloses a plain generally rectangular insert. FIG. 21 discloses a frustoconical insert with a hard layer bonded to a substrate. FIG. 22 discloses a generally conical insert with a rounded tip. A non-planar interface is also disclosed. FIG. 23 discloses a slightly convex top surface of an insert. FIG. 24 discloses a generally pyramidal insert with a generally triangular top.

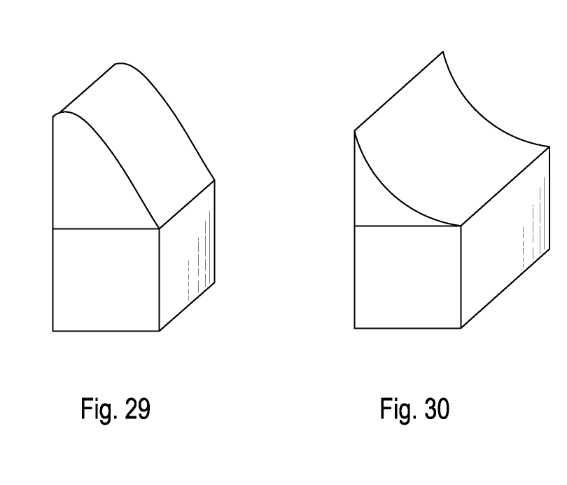

FIGS. 25-30 all disclose an insert with an asymmetric geometry. FIG. 25 discloses an angled face. FIG. 26 discloses an asymmetric rounded top. FIG. 27 discloses a scoop and FIG. 28 discloses an offset protrusion located on a flat face. FIGS. 29 and 30 disclose offset apexes. FIG. 29 discloses rounding to the apex with a convex slope and FIG. 30 discloses rounding to the apex with a concave slope.

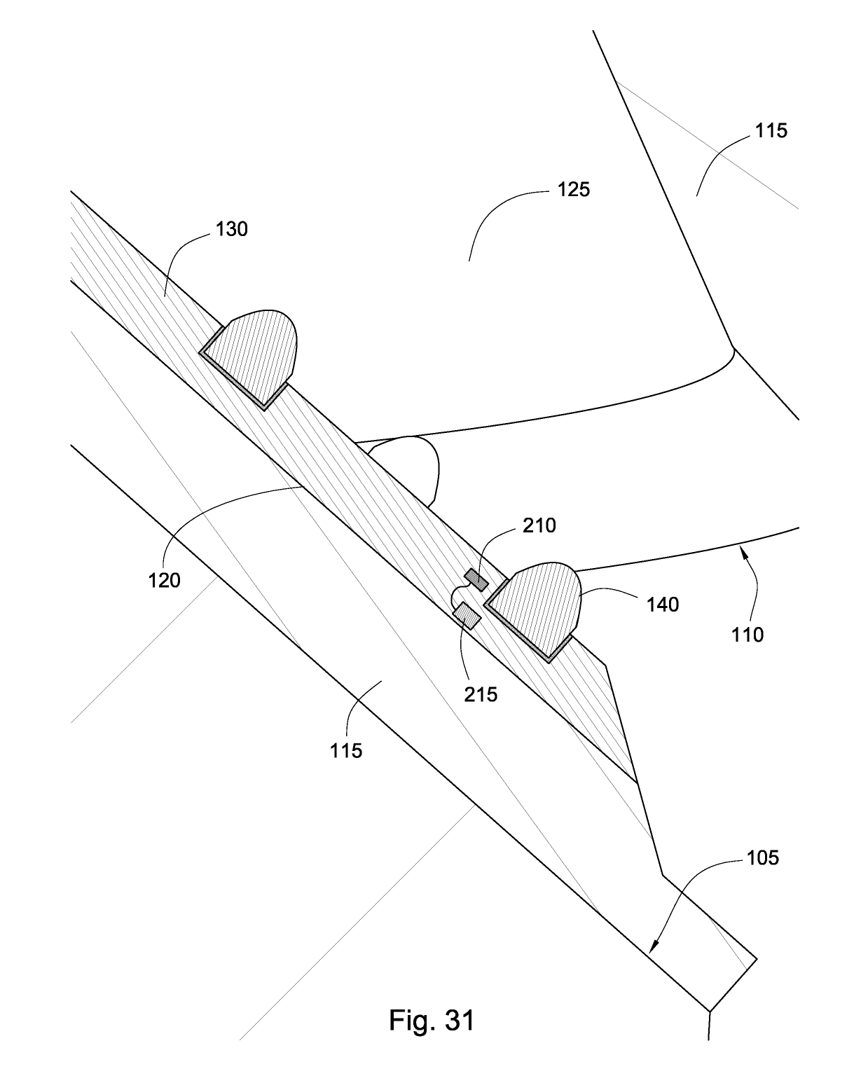

FIG. 31 is a diagram of another embodiment of the replaceable wear liner 115 depicting a sensor 210 being selected from a group consisting of an acoustic transducer, a nuclear transducer, an optical transducer, a capacitor, piezoelectric material, a magnetostrictive material, a solenoid, hydraulics, an actuator, or combinations thereof being coupled with a wireless transceiver 215 both being disposed within the replaceable wear liner 115 of a conical head 105. In other embodiments the sensor 210 and wireless transceiver 215 may be disposed within a portion of the replaceable wear liner 115 of a concave bowl 110. The sensor 210 and wireless transceiver 215 may be disposed within the lower or upper portion of the replaceable wear liner 115 in order to measure vibration, orientation, temperature, pressure, strain, stress, rotational speed, electric potential, position, corrosion, pH, particle density, particle size, wear, distance, displacement, flow rate, magnetism, or combinations thereof and serve to communicate the relevant information to the operator. In other embodiments, the sensor and/or wireless transceiver are disposed within the conical head, but outside of the replaceable wear liner.

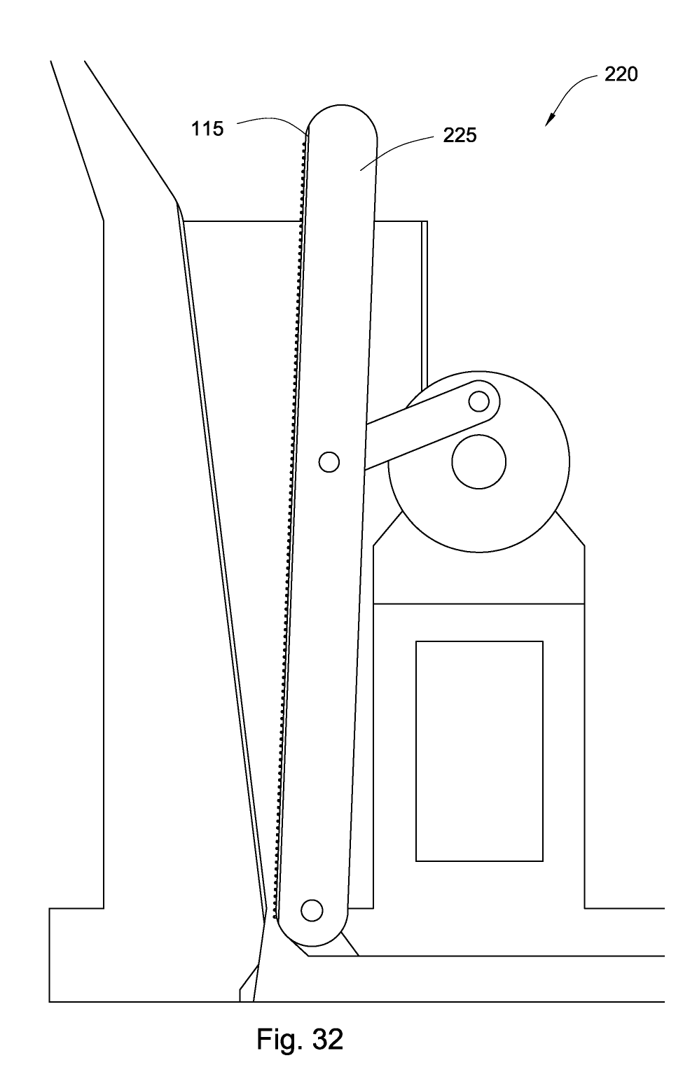

FIG. 32 is a diagram of an embodiment of a jaw crusher in accordance with the present invention where a wall 3000 of at least one jaw 225 may comprise a replaceable wear liner 115 with a plurality of super hard composite inserts 140 disposed within at least a portion of the replaceable wear liner 115. The super hard inserts may be arranged in multiple rows over at least a portion of the replaceable wear liner 115 where the liner is exposed to significant erosion during operation. The replaceable wear liner may be attached to the walls just one of the jaws or both.

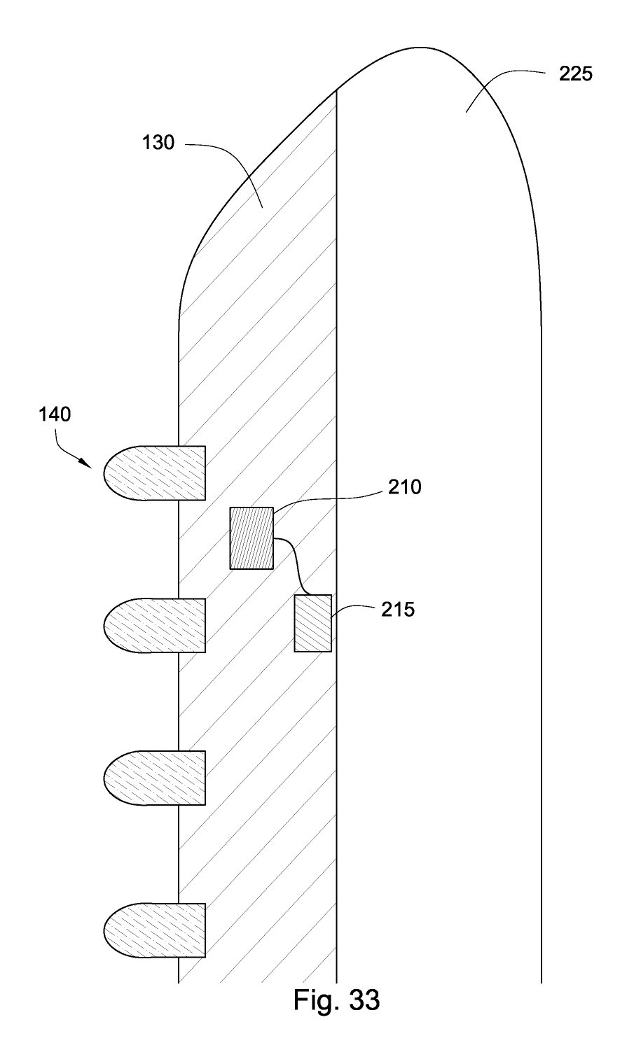

FIG. 33 discloses a sensor 210 and transceiver 215 being disposed within a portion of the replaceable wear liner 115 of the jaw crusher 215.

Whereas the present invention has been described in particular relation to the drawings attached hereto, it should be understood that other and further modifications apart from those shown or suggested herein, may be made within the scope and spirit of the present invention.

1. A replaceable wear liner for incorporation in a cone crusher comprising;
a crushing surface with a plurality of super hard composite inserts disposed within cavities in the crushing surface,
at least one of the plurality of super hard composite inserts extending from said crushing surface and comprising a carbide substrate forming the base segment bonded at a non-planar interface to either a sintered polycrystalline diamond or a sintered polycrystalline cubic boron nitride material which forms a wear resistant tip.

2. The replaceable wear liner of claim 1, wherein the replaceable wear liner comprises a base segment of manganese, steel, stainless steel, or combinations thereof.

3. The replaceable wear liner of claim 1, wherein the replaceable wear liner comprises a second layer of cemented metal carbide base segment comprised of a material selected from the group consisting of tungsten carbide, niobium carbide, and manganese carbide at a thickness of between 0.100 to 0.200 inches.

4. The replaceable wear liner of claim 1, wherein the crushing surface comprises a complementary geometry that corresponds with either a conical head or concave bowl.

5. The replaceable wear liner of claim 1, wherein the cavities are disposed around a peripheral circumference of the replaceable wear liner and form concentric circular rows around the replaceable wear liner.

6. The replaceable wear liner of claim 1, wherein the super hard composite inserts comprises a base segment comprising a material selected from the group consisting of manganese, steel, stainless steel, cemented metal carbide or combinations thereof.

7. (canceled)

8. The super hard material of claim 1, wherein the super hard material is thermally stable.

9. (canceled)

10. The super hard material of claim 1, wherein the super hard material comprises a first layer of polycrystalline diamond with grain distribution of 0.5 to 200 micron.

11. The super hard material of claim 1, wherein the super hard material comprises a second layer of polycrystalline diamond with grain distribution of 0.5 to 300 micron.

12. The super hard material of claim 1, wherein the super hard material is bonded to a non-planar interface with the base segment.

13. The super hard material of claim 1, wherein the super hard material comprises a catalyzing metal concentration substantially equal or less than 40 weight percent.

14. The replaceable wear liner of claim 1, wherein the base segment of the super hard composite insert comprises a tapered or flange end for reception at least one of the cavities.

15. The replaceable wear liner of claim 1, wherein the super hard composite inserts are brazed into the cavities.

16. The replaceable wear liner of claim 1, wherein the super hard composite inserts are press fit into the cavities.

17. The replaceable wear liner of claim 1, wherein at least one insert comprises an axis that forms an angle of less than 75 degrees with a line normal to a tangent of a curvature of the crushing surface.

18. The replaceable wear liner of claim 1, wherein the super hard composite inserts protrude beyond the crushing surface by 0.100 to 3.00 inches.

19. The replaceable wear liner of claim 1, wherein the tip comprises a geometry comprising a generally elliptic paraboloid shape, a generally rounded shape, a generally conical shape, a generally pyramidal shape, a generally triangular shape, a generally frustoconical shape, a generally flat shape, a generally asymmetric shape, a generally domed shape, a generally wedge shape, a generally scoop shape, a general polygonal shape, a chamfer, a conic section, or combinations thereof.

20. The replaceable wear liner of claim 1, wherein the liner comprises a sensor.

21. The replaceable wear liner of claim 20, wherein the sensor is adapted to measure vibration, orientation, temperature, pressure, strain, stress, rotational speed, electric potential, position, corrosion, pH, particle density, particle size, wear, distance, displacement, flow rate, magnetism, or combinations thereof.

22. The replaceable wear liner of claim 20, wherein the sensor comprises an acoustic transducer, a nuclear transducer, an optical transducer, a capacitor, piezoelectric material, a magnetostrictive material, a solenoid, hydraulics, an actuator, or combinations thereof.

23. The replaceable wear liner of claim 20, wherein the replaceable wear liner further comprises a wireless transceiver.

24. A rock crusher, comprising:
a crushing chamber disposed between two opposing walls,
at least one of the walls comprising a replaceable wear liner,
the replaceable wear liner comprising a plurality of super hard composite inserts disposed within a plurality of cavities formed in a crushing surface of the replaceable wear liner,
wherein the super hard composite inserts comprises a layer of sintered polycrystalline diamond or a sintered polycrystalline cubic boron nitride bonded at a non-planar interface with a carbide base segment attached to the replaceable wear liner.

25. The rock crusher of claim 24, wherein the rock crusher further comprises a sensor coupled with a wireless transceiver in communication with the replaceable wear liner.
